(19) United States
(12) Patent Application Publication
(10) Pub. No.: US 2013/0075085 A1
(43) Pub. Date: Mar. 28, 2013

(54) USE OF GLUTAMATE FOR MICROBIAL ENHANCED OIL RECOVERY

(71) Applicant: Robert D. Fallon, Elkton, MD (US)

(72) Inventor: Robert D. Fallon, Elkton, MD (US)

(73) Assignee: E. I. DU PONT DE NEMOURS AND COMPANY, Wilmington, DE (US)

(21) Appl. No.: 13/241,921

(22) Filed: Sep. 23, 2011

(51) Int. Cl. E21B 43/22; C09K 8/58

(52) U.S. Cl. 166/246; 507/241

(57) ABSTRACT

Methods and compositions are provided to enhance oil recovery wherein the indigenous microbial population of an oil reservoir is fed a composition containing glutamate and an electron acceptor. The effect of the glutamate carbon source is to promote bioplugging of a permeable environment by the indigenous microorganisms. Bioplugging in an oil reservoir will improve sweep efficiency thereby leading to enhanced secondary oil recovery.

### FIELD OF THE INVENTION

This disclosure relates to the field of environmental microbiology and modification of crude oil well properties using microorganisms. More specifically, methods and compositions for enhancing oil recovery from an oil reservoir are presented.

### BACKGROUND OF THE INVENTION

During recovery of oil from oil reservoirs, typically only a minor portion of the original oil in the oil-bearing strata is recovered by primary recovery methods which use only the natural forces present in an oil reservoir. To improve oil recovery, a variety of supplemental recovery techniques, such as water flooding which involves injection of water through well bores into the oil reservoir, have been used. As water moves into the reservoir from an injection well and moves through the reservoir strata, it displaces oil to one or more production wells where the oil is recovered. One problem commonly encountered with water flooding operations is poor sweep efficiency of injection water. Poor sweep efficiency occurs when water preferentially channels through highly permeable zones of the oil reservoir as it travels from the injection well(s) to the production well(s), thus bypassing less permeable oil-bearing strata. Oil in the less permeable zones is thus not recovered.

Recovery of oil from subterranean formations may be enhanced by the effects microorganisms that have characteristics such as promoting oil release, and/or forming bioplugs to reduce channeling to improve sweep efficiency. Stimulation of microorganisms that are indigenous to subterranean formations of oil reservoirs and that perform these functions has been disclosed. U.S. Pat. No. 4,558,739 discloses injection into the subterranean formation of a bacterial nutrient that supports bacterial proliferation. U.S. Pat. No. 5,083,611 discloses sequential injection of nutrient components for sustaining microbial activity. In addition, U.S. Pat. No. 5,083,610 discloses adding non-glucose containing carbon source and nutrient to an oil reservoir, followed by nutrient depletion of at least one nutrient, to obtain reduced cell volume.

There remains a need for methods that specifically promote effects of indigenous microorganisms that are beneficial for enhanced oil recovery.

### SUMMARY OF THE INVENTION

The invention relates to methods for enhancing oil recovery from an oil reservoir by supplying glutamate as a carbon source for indigenous microorganisms, which leads to bioplugging in the oil reservoir.

Accordingly, the invention provides a method of enhancing oil recovery from an oil reservoir comprising:
a)) providing an oil reservoir;
b) introducing a composition comprising glutamate and an electron acceptor into said oil reservoir; and
c) recovering oil from said oil reservoir;
wherein glutamate is used as a carbon source by indigenous microorganisms that cause bioplugging in the oil reservoir.

In another embodiment the invention provides an oil recovery enhancing composition comprising:
a) glutamate; and
b) at least one electron acceptor.

### BRIEF DESCRIPTION OF THE DRAWINGS

FIG. 1 is the schematic representation of a water injection well and the subterranean sites adjacent to the water injection well.

FIG. 2 shows a schematic diagram of the slim tube experimental set up used to measure plugging of permeable sand packs.

FIG. 3 shows the Pressure drop (31) and brine feed rate (32) for the slim tube prior to adding nutrients demonstrating stable operation.

FIG. 4 shows the pressure drop (31), brine feed rate (32), and nutrient feeds (33) for the MSG/nitrate fed slim tube.

FIG. 5 shows the pressure drop (31), brine feed rate (32), and nutrient feeds (33) for the alternate nutrient (acetate then lactate) fed slim tube.

### DETAILED DESCRIPTION

Applicants specifically incorporate the entire content of all cited references in this disclosure. Unless stated otherwise, all percentages, parts, ratios, etc., are by weight. Trademarks are shown in upper case. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The following definitions are provided for the special terms and abbreviations used in this application:

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The terms “oil reservoir” and “oil-bearing stratum” may be used herein interchangeably and refer to a subterranean or sub sea-bed formation from which oil may be recovered. The formation is generally a body of rocks and soil having sufficient porosity and permeability to store and transmit oil.

The term “well bore” refers to a channel from the surface to an oil-bearing stratum with enough size to allow for the pumping of fluids either from the surface into the oil-bearing stratum (injection well) or from the oil-bearing stratum to the surface (production well).

The terms “denitrifying” and “denitrification” mean reducing nitrate for use in respiratory energy generation.

The term “water flooding” refers to injecting water through well bores into an oil reservoir. Water flooding is performed to flush out oil from an oil reservoir when the oil no longer flows on its own out of the reservoir.

The term “sweep efficiency” relates to the fraction of an oil-bearing stratum that has seen fluid or water passing through it to move oil to production wells during water flooding. One problem that can be encountered with water flooding operations is the relatively poor sweep efficiency of the water, i.e., the water can channel through certain portions of a reservoir as it travels from injection well(s) to production well(s), thereby bypassing other portions of the reservoir. Poor sweep efficiency may be due, for example, to differences in the mobility of the water versus that of the oil, and permeability variations within the reservoir which encourage flow through some portions of the reservoir and not others.

The term “electron acceptor” refers to a molecular compound that receives or accepts an electron(s) during cellular respiration. Microorganisms obtain energy to grow by transferring electrons from an “electron donor” to an electron acceptor. During this process, the electron acceptor is reduced and the electron donor is oxidized. Examples of acceptors include oxygen, nitrate, fumarate, iron (III), manganese (IV), sulfate or carbon dioxide. Sugars, low molecular weight organic acids, carbohydrates, fatty acids, hydrogen and crude oil or its components such as petroleum hydrocarbons or polycyclic aromatic hydrocarbons are examples of compounds that can act as electron donors.

The term “biofilm” means a film or “biomass layer” of microorganisms. Biofilms are often embedded in extracellular polymers, which adhere to surfaces submerged in, or subjected to, aquatic environments. Biofilms consist of a matrix of a compact mass of microorganisms with structural heterogeneity, which may have genetic diversity, complex community interactions, and an extracellular matrix of polymeric substances.

The term “plugging biofilm” means a biofilm that is able to alter the permeability of a porous material, and thus retard the movement of a fluid through a porous material that is associated with the biofilm.

The term “simple nitrates” and “simple nitrites” refer to nitrate (NO₃) and nitrite (NO₂), respectively.

The term “bioplugging” refers to making permeable material less permeable due to the biological activity, particlularly by a microorganism.

The term “injection water” refers to fluid injected into oil reservoirs for secondary oil recovery. Injection water may be supplied from any suitable source, and may include, for example, sea water, brine, production water, water recovered from an underground aquifer, including those aquifers in contact with the oil, or surface water from a stream, river, pond or lake. As is known in the art, it may be necessary to remove particulate matter including dust, bits of rock or sand and corrosion by-products such as rust from the water prior to injection into the one or more well bores. Methods to remove such particulate matter include filtration, sedimentation and centrifugation.

The term “production water” means water recovered from production fluids extracted from an oil reservoir. The production fluids contain both water used in secondary oil recovery and crude oil produced from the oil reservoir.

The term “glutamate” refers to glutamic acid or any salt of glutamic acid.

The present invention relates to compositions and methods for enhancing oil recovery from an oil reservoir by introducing into the oil reservoir a nutrient composition that contains glutamate as a carbon source and an electron acceptor. Feeding of indigenous microorganisms in the oil reservoir with glutamate leads to plugging of permeable materials. Specifically, bioplugging of permeable rock and sand in the oil reservoir occurs. Bioplugging of permeable rock and sand in oil reservoirs can reroute water towards less permeable, more oil-rich areas leading to improved sweep efficiency and enhanced oil recovery by water flooding. Thus more oil can be obtained by secondary methods, making existing oil wells more productive.

### Glutamate Composition

In the present method a composition containing glutamate is introduced into an oil reservoir. Glutamate may be in the form of any salt of glutamic acid, or glutamic acid itself may in this context be included in the term glutamate. Salts of glutamic acid may include a monosodium or disodium salt, calcium salt, magnesium salt, ammonium or diammonium salt, potassium or dipotassium salt, hydrochloride salt, or hydrated forms of any glutamic acid salt. The L-configuration is preferred over the D-configuration or the DL-mixture. In one embodiment the composition contains monosodium glutamate (MSG).

Glutamate provides a carbon source to support bioplugging by microorganisms that are indigenous to the oil reservoir. It was found, as demonstrated in examples herein, that feeding glutamate to indigenous microorganisms present in oil reservoir injection and production water resulted in bioplugging of a sand and silica mixture. In contrast, feeding with acetate or lactate carbon sources did not result in plugging. Though microorganisms did grow, as evidenced by the utilization of the acetate or lactate carbon source provided, bioplugging did not occur in the presence of these carbon sources. Thus glutamate in particular seems to preferentially enhance the growth of a sub-population of indigenous microorganisms that are able to cause bioplugging. A population of indigenous microorganisms grown in the presence of glutamate also causes stickiness of silica particles. Stickiness and bioplugging suggest the presence of biofilm-forming microorganisms that are beneficial to microbial enhanced oil recovery processes.

The present oil recovery enhancing composition additionally includes an electron acceptor. The electron acceptor may be any molecular compound that receives or accepts an electron(s) during cellular respiration. Typically used electron acceptors for microbial growth are nitrate, fumarate, iron (III), and manganese (IV). In one embodiment the electron acceptor is nitrate. The use of the nitrate electron acceptor can be assessed by its conversion to nitrate, which occurs during microbial metabolism.

The present compositions may include additional components which promote growth of and/or biofilm formation by indigenous microbial strains. These components may include, for example, vitamins, trace metals, salts, nitrogen, phosphorus, magnesium, buffering chemicals, and/or yeast extract. However, though other carbon sources may be present, these are minor components and glutamate is the predominant carbon source in the composition. Glutamate is at least about 80%, 85%, 90%, 95%, or 99% of the carbon source in the present composition.

Composition Introduction into Oil Reservoir and Enhanced Oil Recovery

The glutamate containing composition may be introduced into any oil reservoir. Oil reservoirs may vary in their salinity. In one embodiment the subterranean site of the oil reservoir to which the present composition is introduced is a high salt environment. The salinity of samples from production and/or injection well heads of the oil reservoir may be at least about 35 parts per thousand (ppt), which is similar to the salinity of sea water. The salinity may be higher than 35 ppt, including in the range of 65 to 75 parts per thousand (ppt) which is about twice the salinity of sea water.

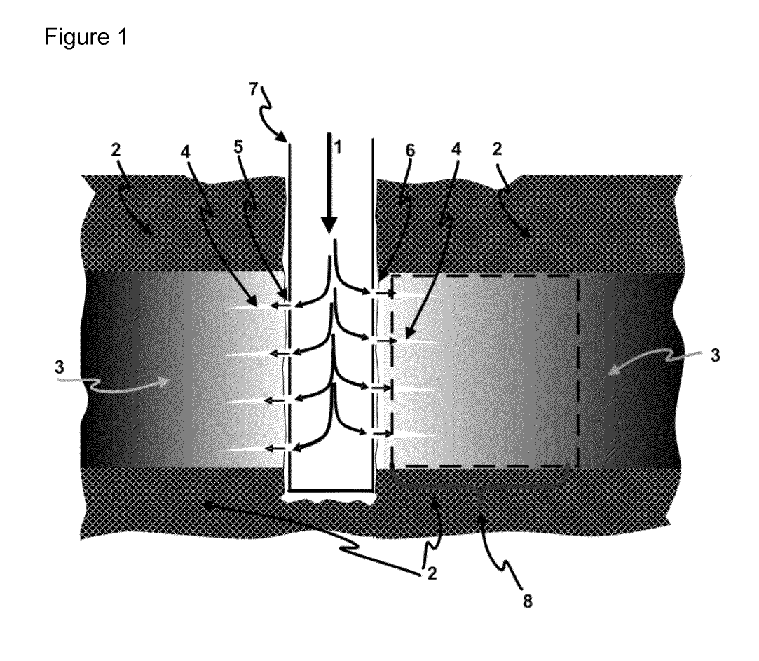

The glutamate containing composition may be introduced into an oil reservoir by any method known to one of skill in the art. Typically the composition is introduced into an oil reservoir by injecting the composition into a water injection well. In one embodiment the present composition flows through the water injection well and into the subterranean sites adjacent to the water injection well as diagrammed in FIG. 1. The present composition (1) flows into the water injection well casing (7) which is inside the well bore (5) drilled through rock layers (2 and 3). A gap exists between the well casing (7) and the face (6) of the rock layer made by the well bore (5). Rock layer (2) represents impermeable rock above and below a permeable rock layer (3) that holds or traps oil. The composition (1) flows down the well casing (7) and passes through perforations in the casing (5) and into fractures (4) in the permeable rock (3). The composition then flows through the permeable rock layer (3) and provides the glutamate carbohydrate source to promote growth of indigenous microorganisms that form bioplugs. This watered zone (8) extends radially out from the well bore (5) in all directions in the permeable rock layer (3). While the volume of permeable rock (3) encompassed by the dash line (8) is illustrated only on one side of the well bore it actually exists on all sides of the well bore. This watered zone represents the subterranean site adjacent to the water injection well.

After introduction of the present composition, a period of time is allowed for growth of the glutamate utilizing indigenous microorganisms. This period of microbial growth may be a week or more. In one embodiment this period is about two to three weeks. Following this period, injection water is introduced into the well bore and it follows the same path as described for the present composition into the subterranean site adjacent to the water injection well. However, now permeable rock is plugged by the glutamate utilizing, bioplug forming microorganisms so that the water displaces oil next to the watered zone adjacent to the well bore. The water containing oil is recovered from at least one production well.

Thus introduction of the present composition causes improvement in the sweep efficiency as follows. Plugging of permeable rock and sand redirects water flow to more oil rich areas. Thus enhanced oil recovery is obtained particularly from oil reservoirs where sweep efficiency is low due to, for example, interspersion in the oil-bearing stratum of rock layers that have a substantially higher permeability compared to the rest of the rock layers. The higher permeability layers will channel water and prevent water penetration to the other parts of the oil-bearing stratum. Formation of plugging biofilms by microorganisms reduces this channeling.

In one embodiment the subterranean site of the oil reservoir is a high salt environment. The salinity of samples from production and injection well heads is about twice that of seawater, in the range of 65 to 75 parts per thousand (ppt).

### EXAMPLES

The present invention is further defined in the following Examples. It should be understood that these Examples, while indicating preferred embodiments of the invention, are given by way of illustration only. From the above discussion and these Examples, one skilled in the art may ascertain the essential characteristics of this invention, and without departing from the spirit and scope thereof, may make various changes and modifications of the invention to adapt it to various usages and conditions.

### General Methods

The meaning of abbreviations are used in this application are as follows: “hr” means hour(s), “min” means minute(s), “day” means day(s), “mL” means milliliters, “mg/mL” means milligram per milliliter, “L” means liters, “μL” means microliters, “mM” means millimolar, “μM” means micromolar, “nM” means nano molar, “μg/L” means microgram per liter, “pmol” means picomol(s), “° C.” means degrees Centigrade, “° F.” means degrees Fahrenheit, “bp” means base pair, “bps” means base pairs, “mm” means millimeter, “ppm” means part per million, “g/L” means gram per liter, “mL/min” means milliliter per minute, “mL/hr” means milliliter per hour, “cfu/mL” means colony forming units per milliliter, “g” means gram, “mg/L” means milligram per liter, “Key” means kilo or thousands of electron volts, “psig” means pounds per square inch gauge (above atmospheric pressure), “LB” means Luria broth, “rpm” means revolution per minute, “NIC” means non-inoculated control.

Samples from Oil Reservoir Production and Injection Waters

A petroleum well system was sampled in the Wainwright field in the province of Alberta, Canada. This well has a salinity of about twice seawater, in the range of 65 to 75 ppt. Water samples were obtained from production and injection well heads as mixed oil/water liquids in 1.0 L bottles, filled to the top, capped and sealed with tape to prevent gas leakage. Gas from inherent anaerobic processes sufficed to maintain anaerobic conditions during shipment. The bottles were shipped in large plastic coolers filled with ice blocks to the testing facilities within 48 hr of sampling.

### Slim Tube Apparatus for Permeability Reduction Assay

An apparatus was designed for measuring bioplugging of permeable horizontal slim tubes.

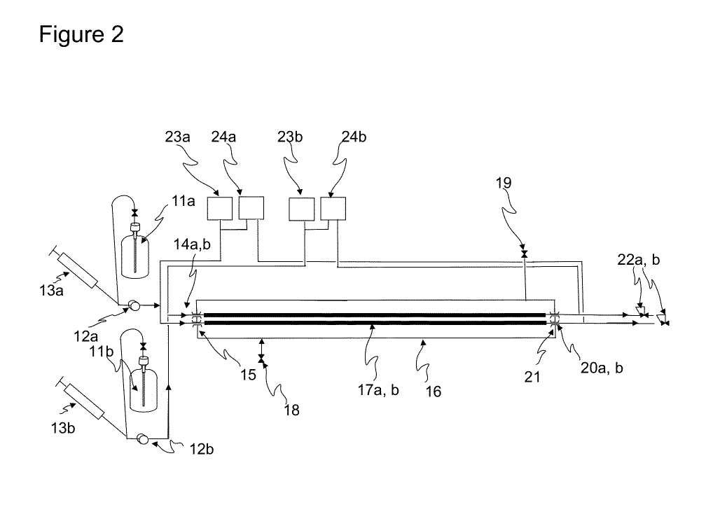

A schematic diagram of the slim tube experimental set up is shown in FIG. 2. All numbers below in bold refer to FIG. 2.

A sample of sand that was obtained from the Schrader Bluff formation at the Milne Point Unit of the Alaska North Slope was cleaned by washing with a solvent made up of a 50/50 (volume/volume) mixture of methanol and toluene. The solvent was subsequently drained and then evaporated off the sand to produce clean, dry, flowable sand. This sand was sieved to remove particles less than one micrometer in size. This sand was combined with washed Sil-co-Sil 125 (U.S. Silica, Berkeley Springs, W. Va.) in a 4:1 ratio, and the mixture was packed tightly into separate four foot (121.92 cm) long, about 1 cm inner diameter, flexible slim tubes (17a, 17b). The sand mix was further compacted by vibration using a laboratory engraver.

Both ends of each slim tube were capped with common compression type fittings to keep the sand mix in the tube. Flexible ⅛ inch (0.32 cm) tubing capable of sustaining the pressures used in the test was attached to the fittings. The slim tubes were mounted into a pressure vessel (16) with the tubing passing through the ends of the pressure vessel (15 and 21) using commonly available pressure fittings (⅛ inch (0.32 cm) union bulkhead) (14a, 14b and 20a, 20b). Additional fittings and tubing were used to connect the inlet of each slim tube to a pressure pump (12a, 12b) and feed reservoir (11a, 11b). When fed with nutrients, concentrated solutions of nutrients were pumped at a low flow rate using common syringe pumps (13a, 13b) and diluted into the brine being fed from the feed reservoir (11a, 11b). Other common compression fittings, including elbows unions and tees, and tubing connected the inlet of each slim tube to a transducer that measured the pressure above atmospheric pressure (absolute pressure gauge) (23a, 23b). The inlet of the slim tube was also connected using the same types of tubing and fittings to the high pressure side of a commonly available differential pressure transducer (24a, 24b). Fittings and tubing connected the outlet of each slim tube to the low pressure side of the differential pressure transducer (24a, 24b) and to a back pressure regulator (22a, 22b). The signals from the differential pressure and the absolute pressure transducers were ported to a computer and these pressure readings were monitored and periodically recorded. The pressure vessel (16) around the slim tubes was filled with water, which acted as a hydraulic fluid, through a water port (18). This water was slowly pressurized with air through port 19 to a pressure of about 110 pounds per square inch (psig) (0.74 mega Pascal) while Brine #1 (below) from the feed reservoirs (11a, 11b) flowed through the slim tubes and came out through the back pressure regulator (22a, 22b). This operation was performed such that the pressure in each slim tube (17a, 17b) was always 5 to 20 psi (0.034-0.137 mega Pascal) below the pressure in the pressure vessel (16).

### Brine and Nutrient Solutions Used for Slim Tube Experiments:

Brine #1: Injection water used at the Wainwright well site in Alberta, Canada. The total dissolved salt content was about 70 ppt. The pH of this solution was adjusted to about 6.2 to 6.4 using HCl or NaOH.

### Nutrients #1

| | |
|---|---|
| Monosodium glutamate (MSG) | 9.0% |
| Sodium Nitrate | 18.0% |
| NH₄Cl | 0.044% |
| NaH₂PO₄*H₂O | 0.88% |
| Yeast Extract | 0.44% |
| Demineralized Water | 71.636% |

### Nutrients #2A

| | |
|---|---|
| Sodium Acetate | 9.0% |
| Sodium Nitrate | 18.0% |
| NH₄Cl | 0.044% |
| NaH₂PO₄*H₂O | 0.88% |
| Yeast Extract | 0.44% |
| Demineralized Water | 71.636% |

### Nutrients #2B

| | |
|---|---|
| Sodium Lactate | 9.0% |
| Sodium Nitrate | 18.0% |
| NH₄Cl | 0.044% |
| NaH₂PO₄*H₂O | 0.88% |
| Yeast Extract | 0.44% |
| Demineralized Water | 71.636% |

### Inoculum for MSG/Nitrate Slim Tube

In Tap water,

10 ppt NaCl,

2000 ppm MSG,

4000 ppm NaNO₃,

200 mg/L yeast extract.

40 ppm NaH₂PO₄*H₂O

200 mg/L NH₄Cl,

Adjust the pH to ˜6.2 to 6.4 with HCl.
(No buffer)
Add 1 part live production water to 1 part of this nutrient mix

### Inoculum for Alternate Nutrient Slim Tube

In Tap water,

10 ppt NaCl,

2000 ppm Nalactate,

4000 ppm NaNO₃,

200 mg/L yeast extract.

40 ppm NaH₂PO₄*H₂O

200 mg/L NH₄Cl,

Adjust the pH to ˜6.2 to 6.4 with HCl.
(No buffer)
Add 1 part live production water to 1 part of this nutrient mix.

### Twice a Week Nutrient Feed Directions:

Run the syringe pump (13a or 13b) at 0.04 cc/hr
Run the brine pump (12a or 12b) at 0.04 cc/min or 2.4 cc/hr
Feed the nutrients for 8 hours, 2 days every week

### Once a Week Nutrient Feed Directions:

Run the syringe pump (13a or 13b) at 0.08 cc/hr
Run the brine pump (12a or 12b) at 0.04 cc/min or 2.4 cc/hr
Feed the nutrients for 8 hours, 1 day every week

### Measurement of Pressure Drop

The pressure drop in the slim tubes was measured using the differential pressure transducer described above. The pressure drop was measured across each slim tube at various flow rates. This pressure drop was approximately proportional to the flow rate. For each pressure drop measured at each flow rate, the base permeability of the slim tube was calculated.

Pressure drop alone can be compared and used as a measure of the change in permeability since the dimensions of the slim tube does not change throughout the test and flow rates did not change during the tests.

The empty volume in the slim tubes, called the pore volume, was 40-50 ml. This pore volume was calculated from the product of the total volume of the slim tube and an estimate of the porosity (˜30% to ˜40%).

### Calculation of Base Permeability

The base permeability was measured using filter sterilized Brine #1 flowing at full pressure: about 95 psi (0.665 megapascal) in each slim tube (controlled at the outlet end with the back pressure regulator) and about 110 psi (0.758 megapascal) in the pressure vessel (6). Base permeability was calculated using the Darcy Equation:

$$k = \frac{4.08 * Q * μ * L}{{A}_{x} * Δ P}$$

ΔP=The pressure drop across a porous pack or rock, [=]psi
Q=Volumetric flow rate through pack, [=]cc/hr
μ=Viscosity of fluid (single phase) through pack [=] centipoise
L=Length of pack (parallel to flow), [=] cm
Aₓ=Cross sectional area (normal to flow) [=] cm²

k=Permeability [=] milliDarcy

4.08=a conversion constant to make the units compatible [=] mD-hr-psi/cp/cc²
Base permeability, along with other properties are given in Table 3.

TABLE 3
Properties of slim tubes

| Tube | Example | Tube ID, | Length, | Mass of | permeability |
|---|---|---|---|---|---|
| # | number | cm | L, cm | sand, gr | Darcy |
| 17a | 1, 2 | 0.978 | 121.9 | 164.0 | 0.5 |
| 17b | 3 | 0.978 | 121.9 | 182.4 | 0.42 |

### Example 1

### Slim Tube Pressure Drop Measurements with and without MSG/Nitrate

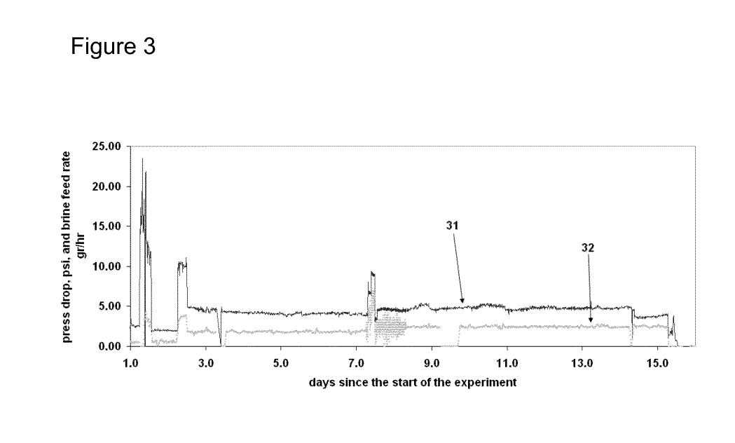

The slim tube set-up described in General Methods was used to measure pressure with flowing brine without any added nutrients. Brine #1 that had been filter sterilized was fed continuously for 13 days to slim tube 17a while the pressure drop across the slim tube was measured as shown for day 3 through day 15 in FIG. 3. FIG. 3 shows pressure drop (31) and brine feed rate (32) for the slim tube. The pressure drop remained about 5 psi (0.0345 mega Pascal). This illustrates the stability of the packed sand in the slim tube while being flooded with the filtered injection brine, as no change in the pressure drop across the slim tube was observed experimentally. This is contrast to when nutrients were fed to this slim tube as described in Example 2, below.

### Example 2

### Slim Tube Pressure Drop Measurements with MSG and Nitrate as Nutrients

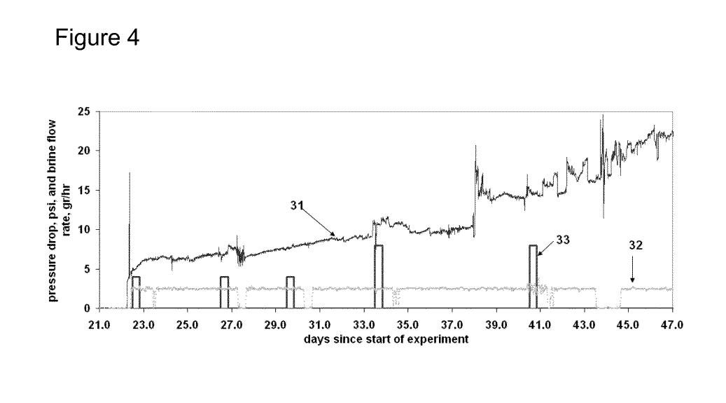

Slim tube 17a of Example 1 was inoculated with 50 ml of a mixture of live water that was produced from oil wells located outside of Wainwright, Alberta, Canada plus nutrients, called “Inoculum for MSG/Nitrate slim tube”, above. The oil field that supplied this live produced water is the same oil field that supplied the injection water called Brine #1, above. The slim tube was inoculated on day 15. The 50 ml of inoculum was pumped into the slim tube for 17 hours and then the slim tube was shut in (no flow to allow microbial growth) until day 22. On day 22, the flow of brine #1 was resumed and the pressure drop was measured. Then on day 22, Nutrients #1 containing MSG as a carbon source were fed to the slim tube using the “Twice a week nutrient feed directions” (above) and pressure drop measurements continued. This nutrient feeding regimen was continued up to day 33. After day 33, the “Once a week nutrient feed directions” (above) were used. Pressure drop measurements (31) and brine feed rate (32) are shown in FIG. 4. The nutrient feedings are illustrated in FIG. 4 as bars such as 33. By day 47, the pressure drop across the slim tube had increased to near 25 psi—a nearly 5× increase compared to the pressure drop before feeding with MSG/nitrate. This corresponds to a dramatic 5× drop in permeability over the 24 days that the slim tube had been fed MSG/nitrate.

### Example 3

### Slim Tube Pressure Drop Measurements with Other Nutrients

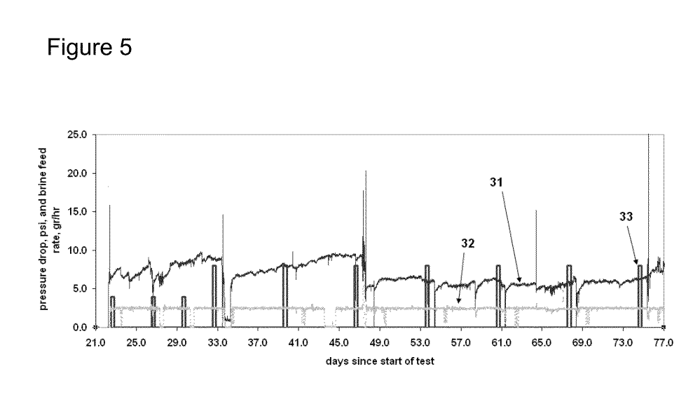

The slim tube set-up described in General Methods was used to measure pressure with flowing brine while using nutrients that did not include MSG. Brine #1 that had been filter sterilized was fed continuously for 13 days to slim tube 17b while the pressure drop across the slim tube was measured. The pressure drop was about 5 to 7 psi (0.0345 to 0.0483 mega Pascal). This illustrates the stability of the packed sand in the slim tube while being flooded with the filtered injection brine, as no substantial change in the pressure drop across the slim tube was observed experimentally. This same slim tube (17b) was inoculated with 50 ml of a mixture of live water that was produced from oil wells located outside of Wainwright, Alberta, Canada plus nutrients (called “Inoculum for alternate nutrient slim tube”, above). The oil field that supplied this live produced water is the same oil field that supplied the injection water called Brine #1, above. The slim tube was inoculated on day 15. The 50 ml of inoculum was pumped into the slim tube for 17 hours and then shut in (no flow to allow microbial growth) until day 22. On day 22, the flow of brine #1 was resumed and the pressure drop was measured. Then on day 22, Nutrients #2A containing acetate as a carbon source were fed to the slim tube using the “Twice a week nutrient feed directions” (above). This nutrient feeding regiment was continued up to day 33. After day 33, the “Once a week nutrient feed directions” were used. Pressure drop measurements (31) and brine feed rate (32) are shown in FIG. 5. The nutrient feedings are illustrated in FIG. 5 as bars such as 33. By day 47, the pressure drop across the slim tube had only increased slightly. This illustrates the ineffectiveness of using Nutrients #2A with only the natural microbes from the wells.

After day 47, Nutrients #2B containing lactate as a carbon source was used with a “Once a week nutrient feed directions”. This feeding regimen was continued until day 77. The pressure drop across this period of time showed no increase (FIG. 5). Effluent samples were collected form the slim tube and analyzed for lactate, acetate, and nitrate/nitrite. There was virtually no lactate and acetate, and no nitrate remaining indicating essentially complete consumption of the nutrients of Nutrients #2A and Nutrient #2B solutions. Contrasting these results to those of Example 2, above, it is clear that MSG/nitrate provides a remarkable permeability modification using only the native microbes present in the oil well system.

### Example 4

### Silica Assay Following Injection Water Enrichment with Different Nutrients

Samples of injection water from the saline Wainwright field described in General Methods were enriched using different compounds as a carbon source. The following additions were made to 10 mL of live injection water, to which 2000 mg/L NaNO₃: had been added previously: 400 μL 65 ppt (parts per thousand) Lauria Broth (LB), 100 μL 5% ACES buffer stock solution (N-(2-Acetamido)-2-aminoethanesulfonic acid), pH 6.5, 100 μl_{—}10% carbon source stock solution (listed in Table 1, column 3), and 100 μL of 220 g/L crystalline silica (grain size range approximately 2-20 microns; Sil-co-Sil 125 made by U.S. Silica, Berkeley Springs, W. Va.). Crystalline silica represents a surrogate for the sand grains common to many subterranean geological formations. The nutrient enriched injection water samples were incubated in capped glass vials for 17 days statically at room temperature. Static incubation and closed vials resulted in oxygen limitation causing nitrate reducing activity. In addition, samples of live injection water to which no nutrients were added, but to which the crystalline silica Sil-co-Sil particle suspension was added, were also incubated at room temperature for 17 days and served as the unenriched controls.

After 16 days of incubation, nitrite concentrations in the enrichment cultures were estimated using nitrite test strips (EMD Chemicals EM Science, #: 10007-1). Results are shown in column 2, Table 1. Controls which tested as having no nitrite at day 6 were not retested. The presence of nitrite is an indicator of nitrate reducing activity. High nitrite concentrations correlation with higher consumption of the carbon source.

At the end of 17 days each vial was gently inverted 10 times and the stickiness of the Sil-co-Sil particles was judged semi-quantitatively by visual inspection. The relative amount of the particle suspension remaining stuck to the bottom of the vial after 10 gentle inversions is shown in Table 1, column 4. This experiment assessed the promotion of adhesive interaction among silica particles and between silica particles and the vial by microorganisms that grow well in the particular carbon source supplied. The results indicated that cultures enriched with monosodium glutamate caused “stickiness” much better than the other carbon sources that were tested). Cultures enriched with sucrose, glycerol, ethylene glycol, actetate, lactate, and propionate showed no more stickiness than the controls, which showed no sticking to the vial bottom. Cultures enriched with citrate, succinate, and butyrate caused some “stickiness”, but were less effective than glutamate. Results of cultures enriched with glucose and fumarate were less effective than glutamante enriched cultures and were inconsistent.

TABLE 1
Silica particle stickiness following injection
water enrichment with different carbon sources

| vial | | | Sil-co-Sil stuck |
|---|---|---|---|
| # | NO₂ | Carbon source | on bottom |
| 1 | 400 | sodium lactate | − |
| 2 | 800 | sodium lactate | − |
| 3 | 200 | ethylene glycol | − |
| 4 | 200 | ethylene glycol | − |
| 5 | 400 | glycerol | − |
| 6 | 800 | glycerol | − |
| 7 | 200 | sodium citrate dihydrate | + |
| 8 | 400 | sodium citrate dihydrate | + |
| 9 | 400 | sodium acetate | − |
| 10 | 400 | sodium acetate | − |
| 11 | 200 | sodium butyrate | ++ |
| 12 | 200 | sodium butyrate | ++ |
| 13 | 100 | sodium propionate | − |
| 14 | 200 | sodium propionate | − |
| 15 | 800 | disodium succinate•6H20 | ++ |
| 16 | 800 | disodium succinate•6H20 | + |
| 17 | 400 | monosodium glutamate | +++ |
| | | monohydrate | |
| 18 | 400 | monosodium glutamate | +++ |
| | | monohydrate | |
| 19 | 50 | glucose | + |
| 20 | 50 | glucose | − |
| 21 | 50 | sucrose | − |
| 22 | 50 | sucrose | − |
| 23 | 200 | fumarate | ++ |
| 24 | 400 | fumarate | − |
| 26 | na* | control | − |
| 27 | na | control | − |
| 28 | na | control | − |

*not assayed

What is claimed is:

1. A method of enhancing oil recovery from an oil reservoir comprising:
a)) providing an oil reservoir;
b) introducing a composition comprising glutamate and an electron acceptor into said oil reservoir; and
c) recovering oil from said oil reservoir;
wherein glutamate is used as a carbon source by indigenous microorganisms that cause bioplugging in the oil reservoir.

2. The method of claim 1 wherein glutamate is at least about 80% of the carbon source in the composition of (b).

3. The method of claim 1 wherein glutamate is selected from the group consisting of glutamic acid, monosodium salt of glutamic acid, disodium salt of glutamic acid, calcium salt of glutamic acid, magnesium salt of glutamic acid, ammonium salt of glutamic acid, diammonium salt of glutamic acid, potassium salt of glutamic acid, dipotassium salt of glutamic acid, hydrochloride salt of glutamic acid, and mixtures thereof including hydrated forms.

4. The method of claim 1 wherein the electron acceptor of (b) is selected from the group consisting of nitrate, fumarate, iron (III), manganese (IV), and mixtures thereof.

5. The method of claim 1 wherein the composition of (b) is injected into an injection well and flows into a subterranean site of the oil reservoir.

6. The method of claim 1 wherein recovery of oil in (c) is by introducing injection water to the oil reservoir following a period of microorganism growth, and recovering the injection water mixed with oil.

7. The method of claim 1 wherein the subterranean site is a high salt environment with at least about 35 ppt salinity.

8. An oil recovery enhancing composition comprising:
a) glutamate; and
b) at least one electron acceptor.

9. The composition of claim 8 wherein glutamate is at least about 80% of the carbon source in the composition.

10. The composition of claim 8 wherein glutamate is selected from the group consisting of glutamic acid, monosodium salt of glutamic acid, disodium salt of glutamic acid, calcium salt of glutamic acid, magnesium salt of glutamic acid, ammonium salt of glutamic acid, diammonium salt of glutamic acid, potassium salt of glutamic acid, dipotassium salt of glutamic acid, hydrochloride salt of glutamic acid, and mixtures thereof including hydrated forms.

11. The composition of claim 8 wherein the electron acceptor of (b) is selected from the group consisting of nitrate, fumarate, iron (III), manganese (IV), and mixtures thereof.
